(19) United States
(12) Patent Application Publication
(10) Pub. No.: US 2026/0221607 A1
(43) Pub. Date: Jul. 30, 2026

(54) Battery Cell, Battery and Battery Cell Manufacturing Method

(71) Applicant: ZHEJIANG LIWINON ENERGY TECHNOLOGY CO., LTD., Jinhua, Zhejiang (CN)

(72) Inventors: Shuwei Tian, Jinhua, Zhejiang (CN); Yonghui Qu, Jinhua, Zhejiang (CN); Cong Li, Jinhua, Zhejiang (CN); Rongjin Ji, Jinhua, Zhejiang (CN); Jie Chen, Jinhua, Zhejiang (CN); Mingqing Zheng, Jinhua, Zhejiang (CN)

(21) Appl. No.: 19/159,026

(22) PCT Filed: Dec. 18, 2023
(86) PCT No.: PCT/CN2023/139500

§ 371 Date: Aug. 22, 2025

(30) Foreign Application Priority Data
May 25, 2023 (CN) 202310604141.3

(51) Int. Cl. H01M 50/533; H01M 50/474

(52) U.S. Cl. CPC H01M 50/533; H01M 50/474

(57) ABSTRACT

A battery cell, comprising: a current collector assembly comprising a main body and current collector tabs, wherein the main body is provided with a connecting end surface, each current collector tab comprises a first portion and a second portion which are connected to each other, the first portion is connected to the connecting end surface, the second portion protrudes from the first portion in the thickness direction of the main body, and the first portion, the second portion and the main body together define a groove; and metal strip tabs each comprising a protruding portion, a connecting portion and a body portion, wherein the connecting portion is connected to the body portion and protrudes from the body portion in the thickness direction of the main body, and the protruding portion is connected to the connecting portion and protrudes from the connecting portion in the width direction of the main body.

### CROSS-REFERENCE TO RELATED APPLICATIONS

This application is the United States national phase of International Patent Application No. PCT/CN 2023/139500 filed Dec. 18, 2023, and claims priority to Chinese Patent Application No. 202310604141.3 filed May 25, 2023, the disclosures of which are hereby incorporated in their entireties.

### BACKGROUND

### TECHNICAL FIELD

The present disclosure relates to the technical field of batteries, and in particular to a battery cell, a battery, and a method for manufacturing the battery cell.

### TECHNICAL CONSIDERATIONS

In the related technologies, a battery cell is formed by welding a tab to a current collector of an electrode sheet, which may indirectly increase a length of the formed battery cell after welding the current collector and the tab. In order to reduce the length of the formed battery cell, the current collector and the tab may typically be bent. Since the current collector and the tab cannot be bent at a place where they are welded (otherwise they would easily be broken at the welding position when bending), there will be a certain distance set between the bending position and the welding position, so as to prevent the welding position between the current collector and the tab from bending.

However, due to the need of a certain distance between the bending position and the welding position of the tab in a thickness direction of the battery cell, a distance between the main body of the tab and the welding position in the thickness direction of the battery cell will be larger, and the tab may exceed the main body of the battery cell in the thickness direction of the battery cell. If the tab exceeds the main body of the battery cell in the thickness direction of the battery cell, it may affect the packaging of the battery cell (for example, packaging the battery cell into an aluminum-plastic film), or it may result in a large space taken up by the tab, thus causing a large loss of battery capacity, and it may also increase the difficulty of smoothly placing the battery cell into a battery compartment of an electronic device.

### SUMMARY

The present disclosure aims to solve at least one of the technical problems in the existing technologies. In view of this, the present disclosure provides a battery cell, in which a metal strip tab can be effectively prevented from exceeding a main body of the battery cell in a thickness direction of the battery cell after a current collector tab and the metal strip tab are connected.

The present disclosure further provides a battery.

The present disclosure further provides a method for manufacturing a battery cell.

In accordance with a first non-limiting aspect of the present disclosure, provided is a battery cell comprising:
a current collector assembly comprising a main body and a current collector tab, wherein the main body is provided with a connecting end surface at one end in a length direction of the main body; the current collector tab comprises a first portion and a second portion which are connected with each other; the first portion is connected to the connecting end surface, the second portion protrudes from the first portion in a thickness direction of the main body, and the first portion, the second portion and the main body together define a groove; and
a metal strip tab comprising a protruding portion, a connecting portion and a body portion, wherein the connecting portion is connected to the body portion and protrudes from the body portion in the thickness direction of the main body; and the protruding portion is connected to the connecting portion and protrudes from the connecting portion in a width direction of the main body;
wherein, the protruding portion is arranged in the groove, and the protruding portion is connected to the second portion; the body portion and the protruding portion are staggered with each other in the thickness direction of the main body; and a projection of the body portion falls within the connecting end surface in the length direction of the main body.

The battery cell according to the non-limiting embodiments of the present disclosure has at least the following beneficial effects: the connection position between the body portion and the connecting portion is the bending position of the metal strip tab, and the portion of the metal strip tab used for connecting with the current collector tab is the protruding portion. Because the body portion and the protruding portion are staggered in the thickness direction of the main body, the bending position of the metal strip tab and the connection position between the metal strip tab and the current collector tab are staggered with each other. In the related technologies, the bending position of the metal strip tab and the connection position between the metal strip tab and the current collector tab are overlapped with each other (in the thickness direction of the battery cell), and a large distance is required between the bending position and the welding position. According to the present disclosure, the bending position and the welding position are staggered, so that the distance between the bending position and the welding position in the thickness direction of the battery cell can be reduced, thereby preventing the body portion from exceeding the main body of the battery cell in the thickness direction of the battery cell, and reducing space occupation.

According to some non-limiting embodiments of the battery cell of the present disclosure, in the width direction of the main body, the second portion has a length shorter than that of the protruding portion.

According to some non-limiting embodiments of the battery cell of the present disclosure, there are two current collector tabs, and the two current collector tabs are arranged at intervals in the width direction of the main body; there are two metal strip tabs, and the two metal strip tabs are arranged at intervals in the width direction of the main body; the two current collector tabs are respectively a first current collector tab and a second current collector tab, and the two metal strip tabs are respectively a first metal strip tab and a second metal strip tab; the protruding portion of the first metal strip tab is connected to the second portion of the first current collector tab so that the body portion of the first metal strip tab is located outside the first current collector tab, and the protruding portion of the second metal strip tab is connected to the second portion of the second current collector tab so that the body portion of the second metal strip tab is located outside the second current collector tab.

According to some non-limiting embodiments of the battery cell of the present disclosure, the battery cell further comprises a tab glue, wherein the tab glue is an insulator, and the connecting portion is wrapped with the tab glue.

According to some non-limiting embodiments of the battery cell of the present disclosure, a part of the body portion is wrapped with the tab glue, and the tab glue has an integrated structure. According to some non-limiting embodiments of the battery cell of the present disclosure, there is an included angle G between the body portion and the connecting portion, and 60°≤G≤120°.

In accordance with a second non-limiting aspect of the present disclosure, provided is a battery, comprising the battery cell according to any one of the embodiments of the first aspect.

The battery according to the non-limiting embodiments of the present disclosure has at least the following beneficial effects: the connection position between the body portion and the connecting portion is the bending position of the metal strip tab, and the portion of the metal strip tab used for connecting with the current collector tab is the protruding portion. Because the body portion and the protruding portion are staggered in the thickness direction of the main body, the bending position of the metal strip tab and the connection position between the metal strip tab and the current collector tab are staggered with each other. In the related technologies, the bending position of the metal strip tab and the connection position between the metal strip tab and the current collector tab are overlapped with each other (in the thickness direction of the battery cell), and a large distance is required between the bending position and the welding position. According to the present disclosure, the bending position and the welding position are staggered, so that the distance between the bending position and the welding position in the thickness direction of the battery cell can be reduced, thereby preventing the body portion from exceeding the main body of the battery cell in the thickness direction of the battery cell. In this way, since the body portion is prevented from exceeding the main body of the battery cell in the thickness direction of the battery cell, the space occupation of the battery cell can be reduced. Therefore, the battery cell can be smoothly placed into the battery compartment of an electronic device. Further, the battery with the battery cell can be smoothly placed into the battery compartment of an electronic device.

In accordance with a third non-limiting aspect of the present disclosure, provided is a method for manufacturing a battery cell, wherein the method is used for connecting a current collector assembly and a metal strip tab, wherein the current collector assembly comprises a main body and a current collector tab, the main body is provided with a connecting end surface at one end in a length direction of the main body, and the current collector tab is connected to the connecting end surface; and
the method for manufacturing the battery cell comprises the following steps:
bending the metal strip tab and the current collector tab respectively, so that the metal strip tab comprises a protruding portion, a connecting portion and a body portion, wherein the connecting portion is connected to the body portion and protrudes from the body portion in a thickness direction of the main body; the protruding portion is connected to the connecting portion and protrudes from the connecting portion in a width direction of the main body; and the current collector tab comprises a first portion and a second portion which are connected with each other, the first portion is connected to the connecting end surface, the second portion protrudes from the first portion in the thickness direction of the main body, and the first portion, the second portion and the main body together define a groove; and
after bending the metal strip tab and the current collector tab respectively, arranging the protruding portion in the groove, and connecting the protruding portion and the second portion, so that the body portion and the protruding portion are staggered with each other in the thickness direction of the main body; and a projection of the body portion falls within the connecting end surface in the length direction of the main body.

The manufacturing method of the battery cell according to the non-limiting embodiments of the present disclosure has at least the following beneficial effects: the connection position between the body portion and the connecting portion is the bending position of the metal strip tab, and the portion of the metal strip tab used for connecting with the current collector tab is the protruding portion. Because the body portion and the protruding portion are staggered in the thickness direction of the main body, the bending position of the metal strip tab and the connection position between the metal strip tab and the current collector tab are staggered with each other. In the related technologies, the bending position of the metal strip tab and the connection position between the metal strip tab and the current collector tab are overlapped with each other (in the thickness direction of the battery cell), and a large distance is required between the bending position and the welding position. According to the present disclosure, the bending position and the welding position are staggered, so that the distance between the bending position and the welding position in the thickness direction of the battery cell can be reduced, thereby preventing the body portion from exceeding the main body of the battery cell in the thickness direction of the battery cell. In this way, according to the battery cell manufactured by the battery cell manufacturing method of the present disclosure, the metal strip tab can be effectively prevented from exceeding the main body of the battery cell in the thickness direction of the battery cell after the current collector tab and the metal strip tab are connected.

In accordance with a third aspect of the present disclosure, provided is a method for manufacturing a battery cell, wherein the method is used for connecting a current collector assembly and a metal strip tab, wherein the current collector assembly comprises a main body and a current collector tab, the main body is provided with a connecting end surface at one end in a length direction of the main body, and the current collector tab is connected to the connecting end surface; and
the method for manufacturing the battery cell comprises the following steps:
bending the metal strip tab, so that the metal strip tab comprises a protruding portion, a connecting portion and a body portion, wherein the connecting portion is connected to the body portion and protrudes from the body portion in a thickness direction of the main body; and the protruding portion is connected to the connecting portion and protrudes from the connecting portion in a width direction of the main body;
after bending the metal strip tab, connecting the protruding portion and the current collector tab;
after connecting the protruding portion and the current collector tab, bending the current collector tab, so that the current collector tab comprises a first portion and a second portion which are connected with each other, the first portion is connected to the connecting end surface, and the second portion protrudes from the first portion in the thickness direction of the main body; and
after bending the current collector tab, forming the battery cell so that the body portion and the protruding portion are staggered with each other in the thickness direction of the main body; and a projection of the body portion falls within the connecting end surface in the length direction of the main body.

The manufacturing method of the battery cell according to the non-limiting embodiments of the present disclosure has at least the following beneficial effects: the connection position between the body portion and the connecting portion is the bending position of the metal strip tab, and the portion of the metal strip tab used for connecting with the current collector tab is the protruding portion. Because the body portion and the protruding portion are staggered in the thickness direction of the main body, the bending position of the metal strip tab and the connection position between the metal strip tab and the current collector tab are staggered with each other. In the related technologies, the bending position of the metal strip tab and the connection position between the metal strip tab and the current collector tab are overlapped with each other (in the thickness direction of the battery cell), and a large distance is required between the bending position and the welding position. According to the present disclosure, the bending position and the welding position are staggered, so that the distance between the bending position and the welding position in the thickness direction of the battery cell can be reduced, thereby preventing the body portion from exceeding the main body of the battery cell in the thickness direction of the battery cell. In this way, according to the battery cell manufactured by the battery cell manufacturing method of the present disclosure, the metal strip tab can be effectively prevented from exceeding the main body of the battery cell in the thickness direction of the battery cell after the current collector tab and the metal strip tab are connected.

In accordance with a third aspect of the present disclosure, provided is a method for manufacturing a battery cell, wherein the method is used for connecting a current collector assembly and a metal strip tab, wherein the current collector assembly comprises a main body and a current collector tab, the main body is provided with a connecting end surface at one end in a length direction of the main body, and the current collector tab is connected to the connecting end surface; and
the method for manufacturing the battery cell comprises the following steps:
connecting the metal strip tab and the current collector tab;
after connecting the metal strip tab and the current collector tab, bending the metal strip tab and the current collector tab respectively, so that the current collector tab comprises a first portion and a second portion which are connected with each other, the first portion is connected to the connecting end surface, and the second portion protrudes from the first portion in a thickness direction of the main body; the metal strip tab comprises a protruding portion, a connecting portion and a body portion, wherein the connecting portion is connected to the body portion and protrudes from the body portion in the thickness direction of the main body; and the protruding portion is connected to the connecting portion and protrudes from the connecting portion in a width direction of the main body; and
after bending the metal strip tab and the current collector tab respectively, forming the battery cell so that the body portion and the protruding portion are staggered with each other in the thickness direction of the main body; and a projection of the body portion falls within the connecting end surface in the length direction of the main body.

The manufacturing method of the battery cell according to the non-limiting embodiments of the present disclosure has at least the following beneficial effects: the connection position between the body portion and the connecting portion is the bending position of the metal strip tab, and the portion of the metal strip tab used for connecting with the current collector tab is the protruding portion. Because the body portion and the protruding portion are staggered in the thickness direction of the main body, the bending position of the metal strip tab and the connection position between the metal strip tab and the current collector tab are staggered with each other. In the related technologies, the bending position of the metal strip tab and the connection position between the metal strip tab and the current collector tab are overlapped with each other (in the thickness direction of the battery cell), and a large distance is required between the bending position and the welding position. According to the present disclosure, the bending position and the welding position are staggered, so that the distance between the bending position and the welding position in the thickness direction of the battery cell can be reduced, thereby preventing the body portion from exceeding the main body of the battery cell in the thickness direction of the battery cell. In this way, according to the battery cell manufactured by the battery cell manufacturing method of the present disclosure, the metal strip tab can be effectively prevented from exceeding the main body of the battery cell in the thickness direction of the battery cell after the current collector tab and the metal strip tab are connected.

Additional aspects and advantages of the present disclosure will be set forth in part in the description below and in part will be obvious from the description below, or will be learned by the practice of the present disclosure.

### BRIEF DESCRIPTION OF THE DRAWINGS

The present disclosure will be further described with reference to the accompanying drawings and the examples, wherein:

FIG. 1 is a top view of a battery cell in the existing technology;

FIG. 2 is a side view of a battery cell according to a first non-limiting embodiment of the present disclosure;

FIG. 3 is a schematic diagram of a battery cell according to a second non-limiting embodiment of the present disclosure;

FIG. 4 is a schematic diagram of a battery cell according to a third non-limiting embodiment of the present disclosure;

FIG. 5 is a schematic diagram of a main body and a current collector tab in a battery cell according to a fourth non-limiting embodiment of the present disclosure;

FIG. 6 is an enlarged view at A in FIG. 5;

FIG. 7 is a schematic diagram of a metal strip tab and a tab glue in a battery cell according to a fifth non-limiting embodiment of the present disclosure;

FIG. 8 is a schematic diagram of a battery cell according to a sixth non-limiting embodiment of the present disclosure;

FIG. 9 is an enlarged view at B in FIG. 8;

FIG. 10 is a schematic diagram of a battery cell according to a seventh non-limiting embodiment of the present disclosure; and

FIG. 11 is an enlarged view at C in FIG. 10.

### REFERENCE SIGNS

Battery cell 100, main body 200, connecting end surface 210, current collector tab 300, first portion 310, second portion 320, groove 330, first current collector tab 340, second current collector tab 350, metal strip tab 400, protruding portion 410, connecting portion 420, body portion 430, first metal strip tab 440, second metal strip tab 450, tab glue 500, and weld 600.

### DETAILED DESCRIPTION

The embodiments of the present disclosure will be described in detail hereinafter, the examples of which are illustrated in the accompanying drawings, wherein the same or similar reference numbers are used to indicate the same or similar elements or the elements having the same or similar functions. The embodiments described below with reference to the accompanying drawings are exemplary and are provided only for the purpose of illustration, and are not intended to limit the present disclosure.

In the description of the present disclosure, it should be understood that the orientation descriptions related to position or positional relationship, such as top, bottom, front, back, left, right, and the like, are based on the position or positional relationship shown in the accompanying drawings, and are only used for the convenience of illustrating the present disclosure and simplifying the description, and are not necessarily intended to indicate or imply that the referred unit or element must have a specific orientation, be constructed and operated in a specific orientation, and therefore should not be understood as a limitation of the present disclosure.

In the description of the present disclosure, “several” means “one or more”, and “more” means “two or more” , and “more than”, “less than”, “exceeding” and so on are understood to exclude the referred value, and “higher”, “lower” and “inclusive” are understood to include the referred value. If used, the reference to “first” or “second” is only for distinguishing the technical features, and it should not be understood as indicating or implying the relative importance or implying the number of the indicated technical features or implying the sequence of the indicated technical features.

In the description of the present disclosure, unless otherwise specified, the words such as “provide”, “arrange”, “connect”, and so on should be understood in a broad sense, and those skilled in the art can reasonably determine the specific meanings of the above words in the present disclosure according to the specific technical solutions.

In the description of the present disclosure, the description with reference to the terms “one embodiment”, “some embodiments”, “exemplary embodiments”, “an example”, “specific example” or “some examples” means that the specific feature, structure, material or characteristic described in connection with the embodiment or example is included in at least one embodiment or example of the present disclosure. In the description of the present disclosure, the exemplary mentions of the above terms do not necessarily refer to the same embodiment or example. Moreover, the specific feature, structure, material or characteristic described may be combined in any one or more embodiments or examples in a suitable manner.

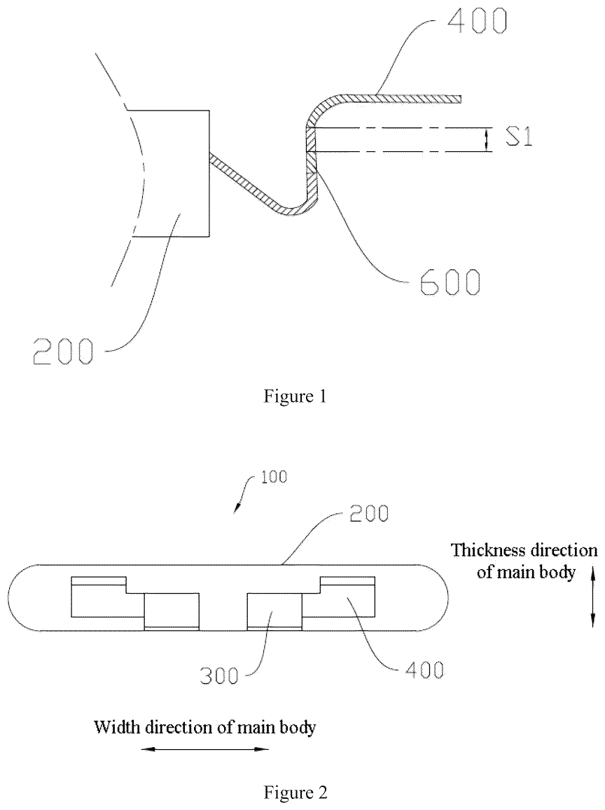

Referring to FIG. 1, it is a schematic diagram of a battery cell 100 in the existing technology, in which a weld is formed after a current collector tab 300 and a metal strip tab 400 are welded. The position of the weld 600 is not for bending, and thus a certain distance S1 is required from a bending position of the current collector tab 300 and the metal strip tab 400 to the weld 600. However, due to the existence of the distance S1, in the existing technology, after the metal strip tab 400 is welded to the current collector tab 300, the metal strip tab 400 exceeds the main body 200 of the battery cell 100 in a thickness direction. In view of this, the present disclosure provides a battery cell 100.

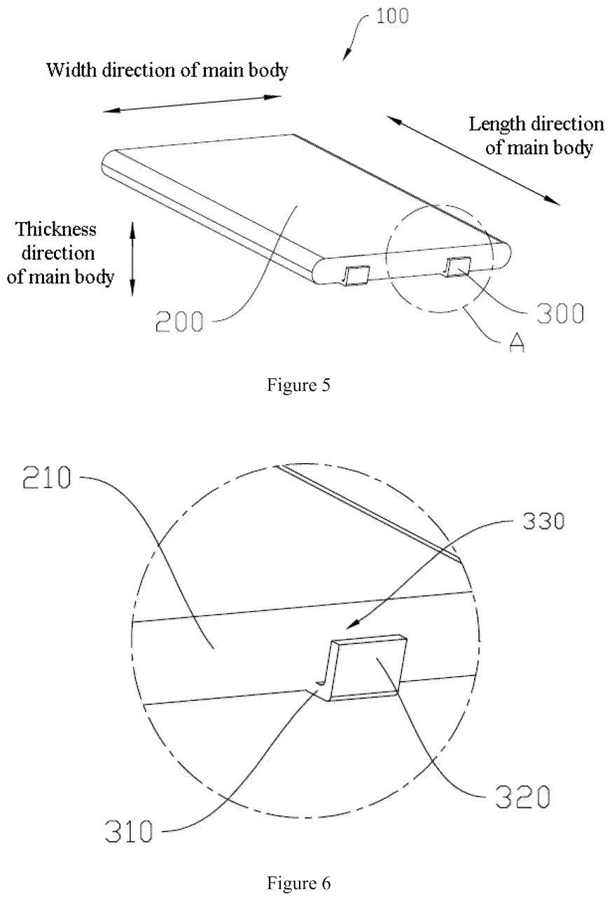

Referring to FIG. 2. In some non-limiting embodiments, the battery cell 100 comprises a current collector assembly and a metal strip tab 400. The current collector assembly comprises a main body 200 and a current collector tab 300. The main body 200 may be formed by winding electrode sheets, or the main body 200 may be formed by stacking electrode sheets. Referring to FIGS. 5 and 6, FIG. 6 is an enlarged view of the current collector tab 300. The main body 200 has a connecting end surface 210, which is located at one end of the main body 200 in a length direction of the main body 200. The current collector tab 300 comprises a first portion 310 and a second portion 320 which are connected with each other. The first portion 310 is connected to the connecting end surface 210, and the second portion 320 protrudes from the first portion 310 in a thickness direction of the main body 200. The first portion 310, the second portion 320 and the main body 200 together define a groove 330. The groove 330 has a through opening in a width direction of the main body 200.

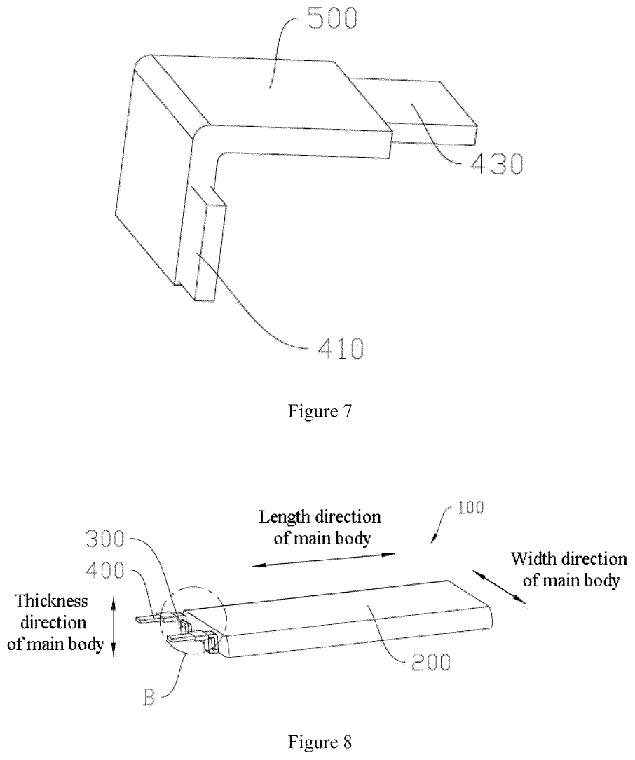

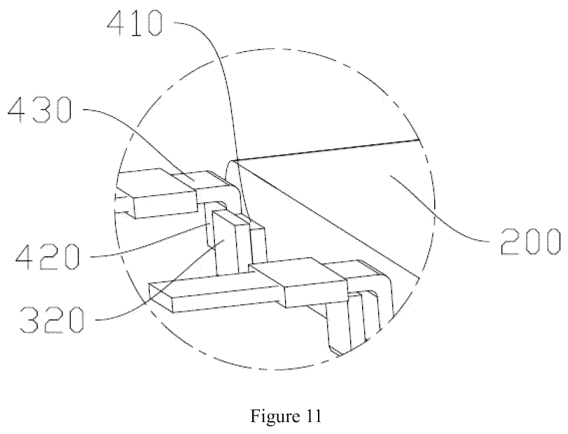

The metal strip tab 400 may be a conductive material with good conductivity, such as copper, aluminum, nickel and nickel-plated copper. Referring to FIG. 7, it illustrates a specific structure in which a connecting portion 420 of the metal strip tab 400 is wrapped with a tab glue 500 in a non-limiting embodiment. The metal strip tab 400 comprises a protruding portion 410, a connecting portion 420 and a body portion 430. Referring to FIG. 11, which shows the connecting portion 420, and the connecting portion 420 is connected to the body portion 430 and protrudes from the body portion 430 in the thickness direction of the main body 200. There is an included angle G between the connecting portion 420 and the body portion 430, and 60°≤G≤120°. The angle G may be 90°. If the included angle between the connecting portion 420 and the body portion 430 is less than 60° or more than 120°, it will be inconvenient for the body portion 430 to connect with a power interface of an external electronic device. The protruding portion 410 is connected to the connecting portion 420 and protrudes from the connecting portion 420 in the width direction of the main body 200. The protruding portion 410 is arranged in the groove 330, and the protruding portion 410 is connected to the second portion 320. In the thickness direction of the main body 200, the body portion 430 and the protruding portion 410 are staggered. The body portion 430 and the protruding portion 410 may be staggered in such a specific way that a projection of the body portion 430 does not fall within a projection area of the protruding portion 410 in the thickness direction of the main body 200. In the length direction of the main body 200, the projection of the body portion 430 falls within the connecting end surface 210. That is, a surface of the body portion 430 does not exceed a surface of the main body 200, otherwise the projection of the body portion 430 will fall outside an area of the end surface of the main body 200 where the first portion 310 is connected.

A connection position between the body portion 430 and the connecting portion 420 is the bending position of the metal strip tab 400, and a portion of the metal strip tab 400 used for connecting with the current collector tab 300 is the protruding portion 410. Because the body portion 430 and the protruding portion 410 are staggered in the thickness direction of the main body 200, the bending position of the metal strip tab 400 and the connection position between the metal strip tab 400 and the current collector tab 300 are staggered with each other. In the related technologies, the bending position of the metal strip tab 400 and the connection position between the metal strip tab 400 and the current collector tab 300 are overlapped with each other (in a thickness direction of the battery cell 100), and a large distance is required between the bending position and the welding position. According to the present disclosure, the bending position and the welding position are staggered, so that the distance between the bending position and the welding position in the thickness direction of the battery cell 100 can be reduced, thereby preventing the body portion 430 from exceeding the main body 200 of the battery cell 100 in the thickness direction of the battery cell 100. The thickness direction of the battery cell 100 is the thickness direction of the main body 200. In this way, according to the battery cell 100 of the present disclosure, after the current collector tab 300 and the metal strip tab 400 are connected, the metal strip tab 400 can be effectively prevented from exceeding the main body 200 of the battery cell 100 in the thickness direction of the battery cell 100, thereby reducing space occupation.

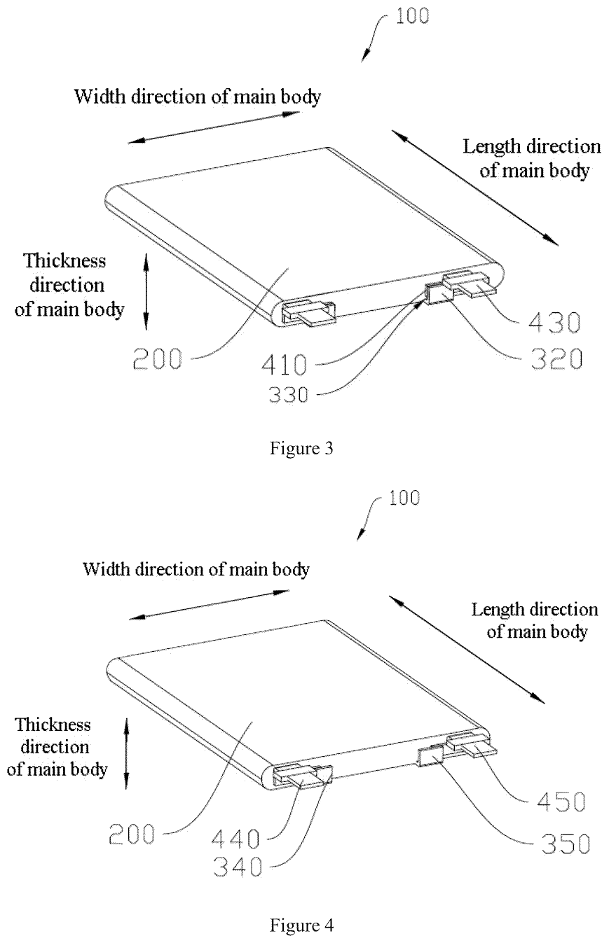

In some non-limiting embodiment, in the width direction of the main body 200, the second portion 320 has a length shorter than that of the protruding portion 410. Because the length of the protruding portion 410 is longer than the length of the second portion 320, a distance between two metal strip tabs 400 can be changed by arranging a part of the protruding portion 410 in the groove 330 and the other part of the protruding portion 410 outside the groove 330, thus increasing the application range of the battery cell 100. Arranging a part of the protruding portion 410 in the groove 330 and the other part of the protruding portion 410 outside the groove 330 may be in such a specific way that one third of the protruding portion 410 is arranged in in the groove 330 and connected to the second portion 320, and two thirds of the protruding portion 410 is outside the groove 330. Alternatively, two thirds of the protruding portion 410 is arranged in in the groove 330 and connected to the second portion 320, and one third of the protruding portion 410 is outside the groove 330. As shown in FIG. 4, all the protruding portion 410 are arranged in the grooves 330. As shown in FIG. 3, a part of the protruding portion 410 is arranged in the groove 330.

Referring to FIG. 2, in some non-limiting embodiments, there are two current collector tabs 300, and the two current collector tabs 300 are arranged at intervals in the width direction of the main body 200. There are two metal strip tabs 400, and the two metal strip tabs 400 are arranged at intervals in the width direction of the main body 200. The two current collector tabs 300 are a first current collector tab 340 and a second current collector tab 350 respectively, and the two metal strip tabs 400 are a first metal strip tab 440 and a second metal strip tab 450 respectively. The protruding portion 410 of the first metal strip tab 440 is connected to the second portion 320 of the first current collector tab 340, so that the body portion 430 of the first metal strip tab 440 is located outside the first current collector tab 340. The protruding portion 410 of the second metal strip tab 450 is connected to the second portion 320 of the second current collector tab 350, so that the body portion 430 of the second metal strip tab 450 is located outside the second current collector tab 350. The outside of the current collector tab 300 may be arranged in such a way that, taking a center of the main body 200 as an origin, a side of the current collector tab 300 near the origin is an inside, and a side of the current collector tab 300 far from the origin is an outside. The metal strip tab 400 may be located outside the current collector tab 300, and the metal strip tab 400 may also be located inside the current collector tab 300. By arranging the metal strip tab 400 on the outside and the inside of the current collector tab 300, the distance between the two metal strip tabs 400 can be changed, thus increasing the application range of the battery cell 100.

Referring to FIG. 7, in some non-limiting embodiments, the battery cell 100 further comprises a tab glue 500, which is an insulator. The tab glue 500 is wrapped around the connecting portion 420. Specifically, because a distance between the connecting portion 420 and the main body 200 is relatively short, when the metal strip tab 400 as a positive electrode contacts the main body 200 formed by stacking electrode sheets, a short circuit may occur. Therefore, in order to avoid the problem of short circuit, all the connecting portions 420 may be insulated by wrapping with the tab glue 500.

Referring to FIG. 7, further in some non-limiting embodiments, the tab glue 500 is also wrapped around a part of the body portion 430, and the tab glue 500 has an integrated structure. After a part of the body portion 430 is wrapped with the tab glue 500, it is convenient to package the battery cell 100 with aluminum-plastic film. Moreover, the integrated tab glue 500 is convenient to process and manufacture.

In some non-limiting embodiments, the battery comprises the battery cell 100 of any of the above embodiments. Specifically, the second portion 320 protrudes from the first portion 310, so that the first portion 310, the second portion 320 and the battery cell 100 together form the groove 330; and further, the protruding portion 410 of the metal strip tab 400 is arranged in the groove 330, so that the projection of the main body 430 and the projection of the protruding portion 410 are staggered in the thickness direction of the main body 200. Therefore, compared with the related technologies in which the bending of the metal strip tab 400 needs to avoid the welding position between the current collector tab 300 and the metal strip tab 400, the projection of the body portion 430 and the projection of the protruding portion 410 of the metal strip tab 400 are staggered according the present disclosure, and thus the body portion 430 can be bent without considering how to keep away from the welding position between the current collector tab 300 and the metal strip tab 400, but only to bend the body portion 430 relative to the connecting portion 420 so that the projection of the body part 430 falls within the end surface of the main body 200 connected to the first part 310. In this way, according to the battery cell 100 of the present disclosure, after the current collector tab 300 and the metal strip tab 400 are connected, the metal strip tab 400 can be effectively prevented from exceeding the main body 200 of the battery cell 100 in the thickness direction of the battery cell 100. Further, the battery with the battery cell 100 can be smoothly placed into the battery compartment of an electronic device.

In addition to the above-described battery cell 100 and the battery, the present disclosure further provides a method for manufacturing a battery cell 100.

In some non-limiting embodiment, the method for manufacturing the battery cell 100 is used to connect a current collector assembly and a metal strip tab 400, wherein the current collector assembly comprises a main body 200 and a current collector tab 300, the main body 200 is provided with a connecting end surface 210 at one end in a length direction of the main body 200, and the current collector tab 300 is connected to the connecting end surface 210; and
the method for manufacturing the battery cell 100 comprises the following steps:

S100, bending the metal strip tab 400 and the current collector tab 300 respectively, so that the metal strip tab 400 comprises a protruding portion 410, a connecting portion 420 and a body portion 430, and the connecting portion 420 is connected to the body portion 430 and protrudes from the body portion 430 in a thickness direction of the main body 200. The protruding portion 410 is connected to the connecting portion 420 and protrudes from the connecting portion 420 in a width direction of the main body 200. The current collector tab 300 comprises a first portion 310 and a second portion 320 which are connected with each other. The first portion 310 is connected to the connecting end surface 210, and the second portion 320 protrudes from the first portion 310 in the thickness direction of the main body 200. The first portion 310, the second portion 320 and the main body 200 together define a groove 330.

S200, after bending the metal strip tab 400 and the current collector tab 300 respectively, arranging the protruding portion 410 in the groove 330, and connecting the protruding portion 410 and the second portion 320, so that the body portion 430 and the protruding portion 410 are staggered in the thickness direction of the main body 200; and a projection of the body portion 430 falls within the connecting end surface 210 in the length direction of the main body 200.

The protruding portion 410 may be connected to the second portion 320 by welding. Specifically, a connection position between the body portion 430 and the connecting portion 420 is a bending position of the metal strip tab 400, and a portion of the metal strip tab 400 used for connecting with the current collector tab 300 is the protruding portion 410. Because the body portion 430 and the protruding portion 410 are staggered in the thickness direction of the main body 200, the bending position of the metal strip tab 400 and the connection position between the metal strip tab 400 and the current collector tab 300 are staggered with each other. In the related technologies, the bending position of the metal strip tab 400 and the connection position between the metal strip tab 400 and the current collector tab 300 are overlapped with each other (in the thickness direction of the battery cell 100), and a large distance is required between the bending position and the welding position. According to the present disclosure, the bending position and the welding position are staggered, so that the distance between the bending position and the welding position in the thickness direction of the battery cell 100 can be reduced, thereby preventing the body portion 430 from exceeding the main body 200 of the battery cell 100 in the thickness direction. In this way, according to the battery cell 100 manufactured by the manufacturing method of the battery cell 100 of the present disclosure, the metal strip tab 400 can be effectively prevented from exceeding the main body 200 of the battery cell 100 in the thickness direction of the battery cell 100 after the current collector tab 300 and the metal strip tab 400 are connected.

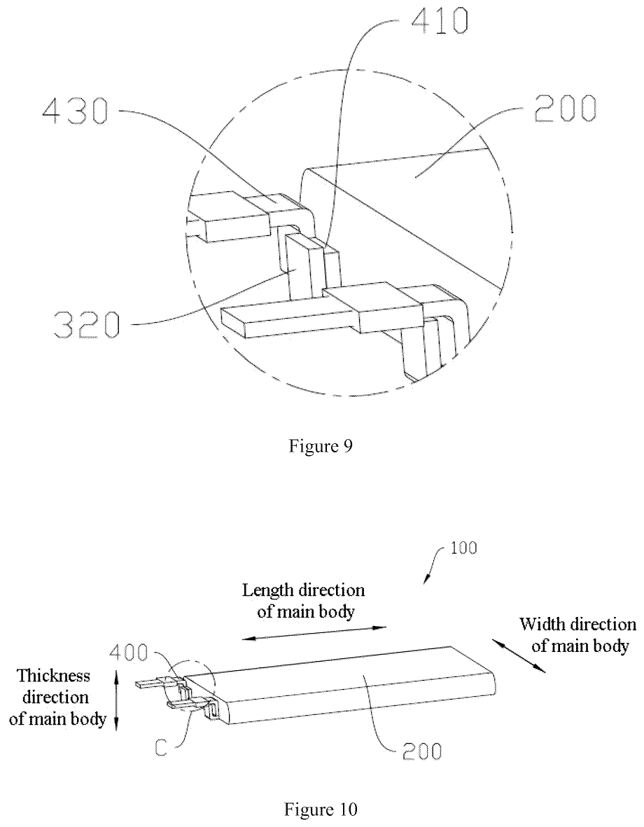

In the manufacturing method of the battery cell 100 of this embodiment, in order to improve the efficiency, the second portion 320 can be bent relative to the first portion 310, and the body portion 430 can be bent relative to the connecting portion 420, and then the metal strip tab 400 can be directly welded to the current collector tab 300. In addition, referring to FIG. 8, FIG. 9, FIG. 10 and FIG. 11, a distance between a surface of the body portion 430 and a surface of the body portion 200 in FIG. 9 is greater than that in FIG. 11, which indicates a large application range of the battery cell 100 of the present disclosure. Such effect is because after the groove 330 and the metal strip tab 400 are formed, the protruding portion 410 can be moved relative to the groove 330, thereby adjusting the distance between the surface of the body portion 430 and the surface of the body 200.

In addition to the above-described manufacturing method of the battery cell 100, the present disclosure further provides the following method for manufacturing a battery cell 100. In some non-limiting embodiments, the method for manufacturing the battery cell 100 is used to connect a current collector assembly and a metal strip tab 400, wherein the current collector assembly comprises a main body 200 and a current collector tab 300, the main body 200 is provided with a connecting end surface 210 at one end in a length direction of the main body 200, and the current collector tab 300 is connected to the connecting end surface 210.

The method for manufacturing the battery cell 100 comprises the following steps:

S100, bending the metal strip tab 400, so that the metal strip tab 400 comprises a protruding portion 410, a connecting portion 420 and a body portion 430, wherein the connecting portion 420 is connected to the body portion 430 and protrudes from the body portion 430 in a thickness direction of the main body 200; and the protruding portion 410 is connected to the connecting portion 420 and protrudes from the connecting portion 420 in a width direction of the main body 200.

S200, after bending the metal strip tab 400, connecting the protruding portion 410 and the current collector tab 300.

S300, after connecting the protruding portion 410 and the current collector tab 300, bending the current collector tab 300, so that the current collector tab 300 comprises a first portion 310 and a second portion 320 which are connected with each other, the first portion 310 is connected to the connecting end surface 210, and the second portion 320 protrudes from the first portion 310 in the thickness direction of the main body 200.

S400, after bending the current collector tab 300, forming the battery cell so that the body portion 430 and the protruding portion 410 are staggered in the thickness direction of the main body 200, and a projection of the body portion 430 falls within the connecting end surface 210 in the length direction of the main body 200.

The protruding portion 410 may be connected to the second portion 320 by welding. Specifically, a connection position between the body portion 430 and the connecting portion 420 is a bending position of the metal strip tab 400, and a portion of the metal strip tab 400 used for connecting with the current collector tab 300 is the protruding portion 410. Because the body portion 430 and the protruding portion 410 are staggered in the thickness direction of the main body 200, the bending position of the metal strip tab 400 and the connection position between the metal strip tab 400 and the current collector tab 300 are staggered with each other. In the related technologies, the bending position of the metal strip tab 400 and the connection position between the metal strip tab 400 and the current collector tab 300 are overlapped with each other (in the thickness direction of the battery cell 100), and a large distance is required between the bending position and the welding position. According to the present disclosure, the bending position and the welding position are staggered, so that the distance between the bending position and the welding position in the thickness direction of the battery cell 100 can be reduced, thereby preventing the body portion 430 from exceeding the main body 200 of the battery cell 100 in the thickness direction. In this way, according to the battery cell 100 manufactured by the manufacturing method of the battery cell 100 of the present disclosure, the metal strip tab 400 can be effectively prevented from exceeding the main body 200 of the battery cell 100 in the thickness direction of the battery cell 100 after the current collector tab 300 and the metal strip tab 400 are connected.

In the manufacturing method of the battery cell 100 of this embodiment, the metal strip tab 400 may be processed first, and after the protruding portion 410 and the second portion 320 are connected, the second portion 320 can be bent relative to the first portion 310.

In addition to the above-described manufacturing method of the battery cell 100, the present disclosure further provides the following method for manufacturing a battery cell 100. In some non-limiting embodiments, the method for manufacturing the battery cell 100 is used to connect a current collector assembly and a metal strip tab 400, wherein the current collector assembly comprises a main body 200 and a current collector tab 300, the main body 200 is provided with a connecting end surface 210 at one end in a length direction of the main body 200, and the current collector tab 300 is connected to the connecting end surface 210.

The method for manufacturing the battery cell 100 comprises the following steps:

S100, connecting the metal strip tab 400 and the current collector tab 300.

S200, after connecting the metal strip tab 400 and the current collector tab 300, bending the metal strip tab 400 and the current collector tab 300 respectively, so that the current collector tab 300 comprises a first portion 310 and a second portion 320 which are connected with each other, the first portion 310 is connected to the connecting end surface 210, and the second portion 320 protrudes from the first portion 310 in a thickness direction of the main body 200; the metal strip tab 400 comprises a protruding portion 410, a connecting portion 420 and a body portion 430, wherein the connecting portion 420 is connected to the body portion 430 and protrudes from the body portion 430 in the thickness direction of the main body 200; and the protruding portion 410 is connected to the connecting portion 420 and protrudes from the connecting portion 420 in a width direction of the main body 200.

S300, after bending the metal strip tab 400 and the current collector tab 300 respectively, forming the battery cell so that the body portion 430 and the protruding portion 410 are staggered with each other in the thickness direction of the main body 200; and a projection of the body portion 430 falls within the connecting end surface 210 in the length direction of the main body 210.

The protruding portion 410 may be connected to the second portion 320 by welding. Specifically, a connection position between the body portion 430 and the connecting portion 420 is a bending position of the metal strip tab 400, and a portion of the metal strip tab 400 used for connecting with the current collector tab 300 is the protruding portion 410. Because the body portion 430 and the protruding portion 410 are staggered in the thickness direction of the main body 200, the bending position of the metal strip tab 400 and the connection position between the metal strip tab 400 and the current collector tab 300 are staggered with each other. In the related technologies, the bending position of the metal strip tab 400 and the connection position between the metal strip tab 400 and the current collector tab 300 are overlapped with each other (in the thickness direction of the battery cell 100), and a large distance is required between the bending position and the welding position. According to the present disclosure, the bending position and the welding position are staggered, so that the distance between the bending position and the welding position in the thickness direction of the battery cell 100 can be reduced, thereby preventing the body portion 430 from exceeding the main body 200 of the battery cell 100 in the thickness direction. In this way, according to the battery cell 100 manufactured by the manufacturing method of the battery cell 100 of the present disclosure, the metal strip tab 400 can be effectively prevented from exceeding the main body 200 of the battery cell 100 in the thickness direction of the battery cell 100 after the current collector tab 300 and the metal strip tab 400 are connected.

In the manufacturing method of the battery cell 100 of this embodiment, after the protruding portion 410 and the second portion 320 are connected, the connection positions of the first portion 310 and the second portion 320 can be bent respectively, and then connection position between the connecting portion 420 and the body portion 430 can be bent.

The embodiments of the present disclosure have been described in detail with reference to the accompanying drawings, but the above embodiments are not intended to limit the scope of the present disclosure. Many variations can be made within the knowledge of those ordinary skilled in the art without departing from the purpose of the present disclosure. In addition, the embodiments and the features in embodiments of the present disclosure can be combined with each other without conflict.

What is claimed is:

1. A battery cell, comprising:
a current collector assembly comprising a main body and a current collector tab, wherein the main body is provided with a connecting end surface at one end of a length direction of the main body; the current collector tab comprises a first portion and a second portion which are connected with each other; the first portion is connected to the connecting end surface, and the second portion protrudes from the first portion in a thickness direction of the main body; and the first portion, the second portion and the main body together define a groove; and
a metal strip tab comprising a protruding portion, a connecting portion and a body portion, wherein the connecting portion is connected to the body portion and protrudes from the body portion in a thickness direction of the main body; and the protruding portion is connected to the connecting portion and protrudes from the connecting portion in a width direction of the main body;
wherein, the protruding portion is arranged in the groove, and the protruding portion is connected to the second portion; the body portion and the protruding portion are staggered with each other in the thickness direction of the main body; and a projection of the body portion falls within the connecting end surface in the length direction of the main body.

2. The battery cell according to claim 1, wherein, in the width direction of the main body, the second portion has a length shorter than that of the protruding portion.

3. The battery cell according to claim 2, wherein, there are two current collector tabs, and the two current collector tabs are arranged at intervals in the width direction of the main body; there are two metal strip tabs, and the two metal strip tabs are arranged at intervals in the width direction of the main body;
the two current collector tabs are respectively a first current collector tab and a second current collector tab, and the two metal strip tabs are respectively a first metal strip tab and a second metal strip tab; and
the protruding portion of the first metal strip tab is connected to the second portion of the first current collector so that the body portion of the first metal strip tab is located outside the first current collector tab, and the protruding portion of the second metal strip tab is connected to the second portion of the second current collector so that the body portion of the second metal strip tab is located outside the second current collector tab.

4. The battery cell according to claim 1, further comprising a tab glue, wherein the tab glue is an insulator, and the connecting portion is wrapped with the tab glue.

5. The battery cell according to claim 4, wherein, a part of the body portion is wrapped with the tab glue, and the tab glue has an integrated structure.

6. The battery cell according to claim 1, wherein, there is an included angle G between the body portion and the connecting portion, and 60°≤G≤120°.

7. A battery, comprising the battery cell according to claim 1.

8. A method for manufacturing a battery cell according to claim 1, wherein, the method is used for connecting a current collector assembly and a metal strip tab, the current collector assembly comprises a main body and a current collector tab, the main body is provided with a connecting end surface at one end in a length direction of the main body, and the current collector tab is connected to the connecting end surface; and
the method comprises the following steps:
bending the metal strip tab and the current collector tab respectively, so that the metal strip tab comprises a protruding portion, a connecting portion and a body portion, wherein the connecting portion is connected to the body portion and protrudes from the body portion in a thickness direction of the main body; the protruding portion is connected to the connecting portion and protrudes from the connecting portion in a width direction of the main body; and the current collector tab comprises a first portion and a second portion which are connected with each other, the first portion is connected to the connecting end surface, the second portion protrudes from the first portion in the thickness direction of the main body, and the first portion, the second portion and the main body together define a groove; and
after bending the metal strip tab and the current collector tab respectively, arranging the protruding portion in the groove, and connecting the protruding portion and the second portion, so that the body portion and the protruding portion are staggered with each other in the thickness direction of the main body; and a projection of the body portion falls within the connecting end surface in the length direction of the main body.

9. A method for manufacturing a battery cell according to claim 1, wherein, the method is used for connecting a current collector assembly and a metal strip tab, the current collector assembly comprises a main body and a current collector tab, the main body is provided with a connecting end surface at one end in a length direction of the main body, and the current collector tab is connected to the connecting end surface; and
the method comprises the following steps:
bending the metal strip tab, so that the metal strip tab comprises a protruding portion, a connecting portion and a body portion, wherein the connecting portion is connected to the body portion and protrudes from the body portion in a thickness direction of the main body; and the protruding portion is connected to the connecting portion and protrudes from the connecting portion in a width direction of the main body;
after bending the metal strip tab, connecting the protruding portion and the current collector tab;
after connecting the protruding portion and the current collector tab, bending the current collector tab, so that the current collector tab comprises a first portion and a second portion which are connected with each other, the first portion is connected to the connecting end surface, and the second portion protrudes from the first portion in the thickness direction of the main body; and
after bending the current collector tab, forming the battery cell so that the body portion and the protruding portion are staggered with each other in the thickness direction of the main body, and a projection of the body portion falls within the connecting end surface in the length direction of the main body.

10. A method for manufacturing a battery cell according to claim 1, wherein, the method is used for connecting a current collector assembly and a metal strip tab, the current collector assembly comprises a main body and a current collector tab, the main body is provided with a connecting end surface at one end in a length direction of the main body, and the current collector tab is connected to the connecting end surface; and
the method comprises the following steps:
connecting the metal strip tab and the current collector tab;
after connecting the metal strip tab and the current collector tab, bending the metal strip tab and the current collector tab respectively, so that the current collector tab comprises a first portion and a second portion which are connected with each other, the first portion is connected to the connecting end surface, and the second portion protrudes from the first portion in a thickness direction of the main body; the metal strip tab comprises a protruding portion, a connecting portion and a body portion, wherein the connecting portion is connected to the body portion and protrudes from the body portion in the thickness direction of the main body; and the protruding portion is connected to the connecting portion and protrudes from the connecting portion in a width direction of the main body; and
after bending the metal strip tab and the current collector tab respectively, forming the battery cell so that the body portion and the protruding portion are staggered with each other in the thickness direction of the main body; and a projection of the body portion falls within the connecting end surface in the length direction of the main body.

11. A battery, comprising the battery cell according to claim 2.

12. A battery, comprising the battery cell according to claim 3.

13. A battery, comprising the battery cell according to claim 4.

14. A battery, comprising the battery cell according to claim 5.

15. A battery, comprising the battery cell according to claim 6.
